(19) United States
(12) Patent Application Publication
(10) Pub. No.: US 2018/0079505 A1
(43) Pub. Date: Mar. 22, 2018

(54) Oval Lifting-Body Airplane

(71) Applicant: Laszlo Molnar, Mukilteo, WA (US)

(72) Inventor: Laszlo Molnar, Mukilteo, WA (US)

(21) Appl. No.: 15/268,059

(22) Filed: Sep. 16, 2016

(51) Int. Cl. B64C 39/10; B64C 13/50; B64C 9/00; B64D 31/00

(52) U.S. Cl. CPC B64C 39/10; B64D 31/00; B64C 9/00; B64C 13/503

(57) ABSTRACT

An oval lifting-body airplane may generate lift without wings. It may be propelled by a pivoting propulsion engine attached to an upper surface, allowing it to fly substantially parallel to the oval's major axis or the oval's minor axis, allowing different configurations for landing and takeoff than for cruising.

### FIELD

This disclosure generally relates to an oval lifting-body airplane.

### BACKGROUND

Airplanes are heavier-than-air machines that fly. They may be propelled forward by thrust from a jet engine or propeller. Air moves over and under the body and wings of the airplane as it is propelled forward and creates lift, which enables the airplane to stay in the air and fly. Airplanes may come in a variety of sizes, shapes, or wing configurations, and are made using a variety of materials. Since the Wright Brothers made their first flight, most airplanes have used and evolved slender wings to produce lift. These slender wings may be attached to a cylindrical fuselage with a pressured interior to hold a payload of passengers or cargo.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, an oval lifting-body airplane, which may have less structural weight than other airplanes of similar capacity. It may combine a payload wall with an aerodynamically lifting structure. It may have uniform chords along both a minor axis and a major axis of an oval, which may reduce production complexity and costs. Overall use of volume inside an oval lifting-body airplane may be substantially utilized, with fuel and payload containers occupying shallow internal areas near outside edges of the airplane.

The propulsion engines may be on an upper surface, allowing the landing gear to be shorter in length than landing gear configured for a conventional airplane with the engines mounted on the lower surface of the airplane wings. This may allow an oval lifting-body airplane to use a landing gear of reduced size and weight. Propulsion engines attached to the upper surface of the airplane may also support the development of larger inlet sizes and bypass ratios, which may improve fuel efficiency.

The compact body of an oval lifting-body airplane may reduce weight, production complexity and costs, and operating costs while improving reliability. For example, the electrical wires, hydraulic lines, pneumatic lines, data lines, mechanical linkages, water, and wastewater lines may be shortened. Instead of running along a fuselage and wing, lines may take a more direct route. Airplane fuel consumption per passenger may be reduced by increasing payload floor area, which may allow for a greater number of passengers. An oval lifting-body airplane may have cargo areas, entry ramps, doors, and passenger areas arranged throughout the airplane.

An oval lifting-body airplane may reduce noise issues at ground level as a result of placing propulsion engines above the airplane surface rather than beneath the wings, where many conventional airplanes have engines mounted.

Ascent—(takeoff) and descent—(landing) phase speeds of an oval lifting-body airplane may be lower than other airplanes with similar capacity. The compact body of an oval lifting-body airplane may be durable enough to withstand an accident or may reduce accident damage. For example, an oval lifting-body airplane has no wings to collide with other aircraft or structures, also since its engines are mounted on the upper surface of the airplane they may be intact after an accident. An oval lifting-body airplane may take off after an emergency landing on water, for example.

An oval lifting-body airplane may have a reduced drag compared to a conventional airplane while maintaining lift. A ratio of a lift coefficient over a drag coefficient (Cl/Cd) may be increased by a factor of approximately two to four through the absence of a conventional empennage and optimizing the “area rule” of an oval lifting-body airplane. During ascent—and descent—phases of flight, the oval lifting-body airplane may use a high lift moderate aspect ratio (the ratio of the wingspan to the length of the oval lifting-body airplane in the direction of flight), which may reduce required runway lengths. For cruising phase, the oval lifting-body airplane's body may be rotated approximately 90 degrees, which may reduce the aspect ratio, reduce drag, and allow cruising at approximately Mach 0.85. An oval lifting-body airplane may roll or turn by using left and right control surfaces to control pitch and differential movement to control roll. Control surfaces may be affixed to the trailing edges of the airplane along the minor axis (X-axis) and major axis (Y-axis), may form a protrusion, and may be completely retractable to avoid interference with the operation of the airplane in one axis or another.

An oval lifting-body airplane may be propelled by two propulsion engines attached to the upper surface. These two engines may pivot approximately 90 degrees to propel the airplane along either the X-axis or Y-axis, and they may be offset to permit their use without interference from each other during use along either axis.

An oval lifting-body airplane may be controlled remotely or by a pilot, who may be in the cockpit or in another space in the airplane, or by an autopilot using redundant sensors, processors, and actuators. The cockpit may be located anywhere on an oval lifting-body airplane. Views from the airplane may be visible by use of one or more cameras and video screens.

Many of the attendant features may be more readily appreciated as they become better understood by reference to the following detailed description considered in connection with the attached drawings.

### BRIEF DESCRIPTION OF THE DRAWINGS

FIG. 1 illustrates an isometric view of an oval lifting-body airplane during landing.

FIG. 2 illustrates a top view of an oval lifting-body airplane.

FIG. 3 illustrates a front view of an oval lifting-body airplane with one door open.

FIG. 4 illustrates a side view of an oval lifting-body airplane with one door open.

FIG. 5 illustrates an isometric view of an oval lifting-body airplane as it may look while flying.

FIG. 6 illustrates a top view of an oval lifting-body airplane while flying.

FIG. 7 illustrates a side view of an oval lifting-body airplane while flying.

FIG. 8 is a graph that represents a flight simulation outlining wave drag created by a conventional airplane as compared to an oval lifting-body airplane.

FIG. 9 illustrates an isometric cutaway view of oval lifting-body airplane.

FIG. 10 illustrates a side cutaway view of an oval lifting-body airplane.

FIG. 11 illustrates a section of an arched structural support beam and a portion of a body of an oval lifting-body airplane.

FIG. 12 illustrates a side view of a joint between an arched structural support beam and a lower structural beam.

FIG. 13 illustrates an isometric view of a joint between an arched structural support beam and a lower structural beam.

### DETAILED DESCRIPTION

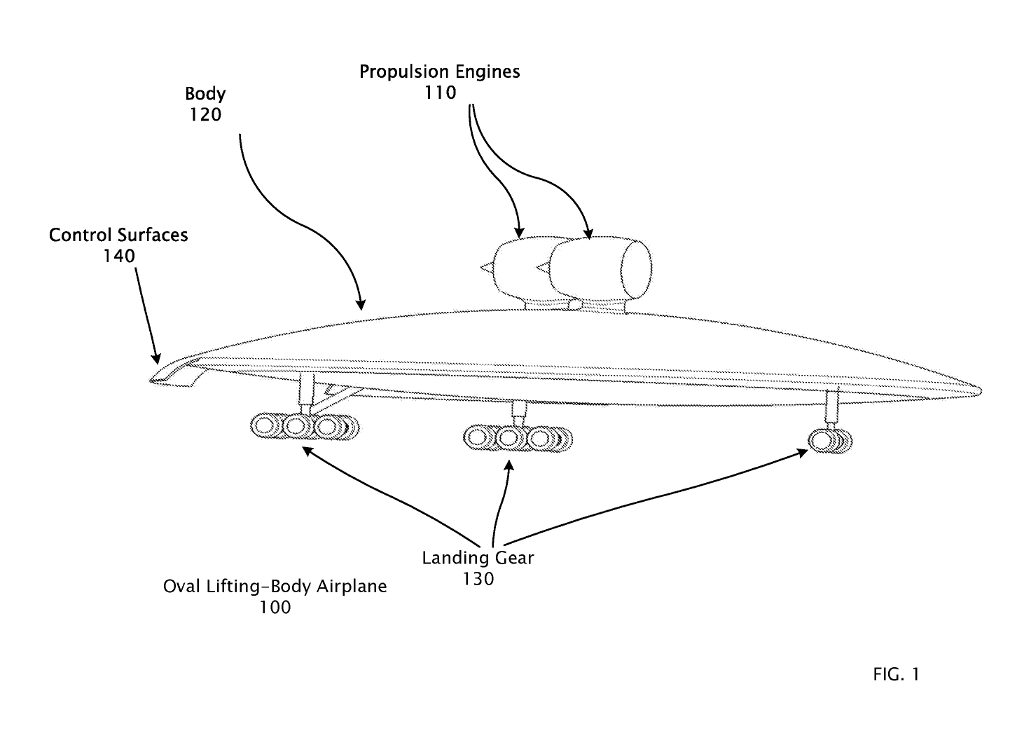

FIG. 1 illustrates an isometric view of Oval Lifting-Body Airplane 100 in a landing configuration. Body 120 may be substantially oval-shaped in the plane of flight, and may have curved Upper Surface 410. For example Body 120 may have an X-axis and a Y-axis, where the X-axis may be a minor or shorter axis, and the Y-axis may be a major or longer axis of the oval. Computer models have tested wingspans in the major axis of 30 to 55 meters.

Body 120 may be made of composite material, metal, or another strong, lightweight material. Body 120 may have Upper Surface 410 supported by Arched Structural Beams 900 and Lower Surface 420 supported by Lower Structural Beams 910.

Oval Lifting-Body Airplane 100 may reduce airplane structural weight, by combining payload walls with an aerodynamically lifting structure. Production complexity and costs may be reduced, by having uniform chord sections in the Body 120's X- and Y-direction. Oval Lifting-Body Airplane 100 may turn by using Control Surfaces 140 to control pitch, yaw, or roll. Control Surfaces 140 may be affixed to the trailing edges of Body 120 along each of the X-axis and Y-axis, may be completely retractable to avoid interference with the operation of the airplane in one axis or another, and may extend behind the Body 120 to increase lift. Control Surfaces 140 may be, for example, one or more of flaps, elevators, ailerons, rudders, slats, air brakes, or any other control surface to adjust attitude.

Propulsion Engines 110 may be one or more piston engines, turbines, electric motors, or other means of propulsion. Propulsion Engines 110 may be attached to Upper Surface 410 of Body 120, which may allow large inlet sizes and bypass ratios for turbine engines, which may provide lower operating costs through improved fuel efficiency.

Landing Gear 130 may extend to below Lower Surface 420 of Body 120, which may facilitate operation of the airplane on the ground. While climbing, ascending, descending, and in cruise flight, Landing Gear 130 may retract into Body 120. With Propulsion Engines 110 on Upper Surface 410 of Body 120, Landing Gear 130 may be shorter in length as compared to a conventional airplane that has engines mounted beneath the wings, since ground clearance for the engines may not be required. Compared to other airplane designs of similar capacity, Oval Lifting-Body Airplane 100 may have fewer movable subassemblies, which may reduce production complexity and costs, reduce operating costs, and increase reliability.

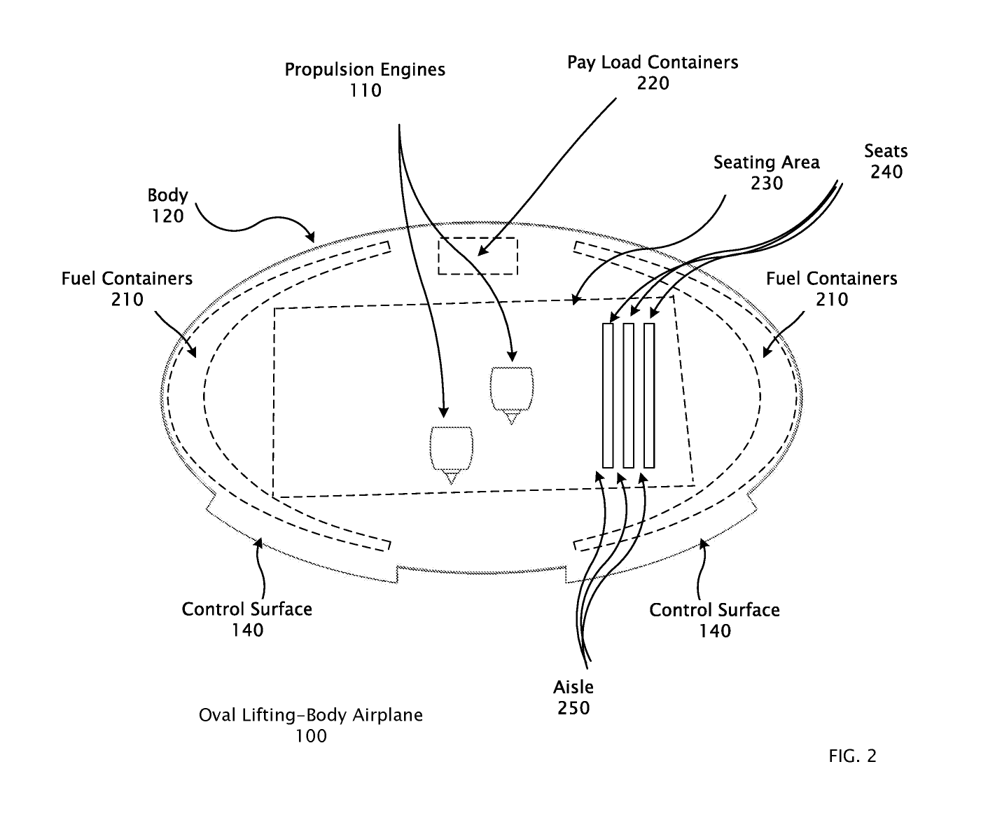

FIG. 2 illustrates a top view of Oval Lifting-Body Airplane 100 in a landing configuration, according to one embodiment. Oval Lifting-Body Airplane 100 may have a low drag force effect. A ratio of a lift coefficient over a drag coefficient (Cl/Cd) may be increased by a factor of two to four compared to other airplane designs of similar capacity due to the absence of an empennage and optimizing the transonic area rule of Oval Lifting-Body Airplane 100, which may reduce drag of the lifting body.

Fuel Containers 210 and Pay Load Containers 220 may be positioned in Oval Lifting-Body Airplane 100's shallow internal area, utilizing the area that is near a circumference of the Oval Lifting-Body Airplane 100. This may allow the use of the valuable, larger interior space to be used for passengers or larger cargo. Seating Area 230 may be configured with more seats than a conventional plane of a similar width, while still providing additional room for each passenger. Seats 240 may be laid out in rows of two seats side-by-side, so that each seat may have access to Aisle 250.

Oval Lifting-Body Airplane 100 may have a large ceiling area, which may be configured to work as a screen on which to project images. Movies, views from outside, safety videos, or other entertainment, educational, or other images may be projected. If a “window view” from outside is projected, it may rotate 90° as Oval Lifting-Body Airplane 100 rotates on takeoff or landing. Seat-back screens may also be available and may have similar images shown.

Propulsion Engines 110 may be attached to Upper Surface 410 of Body 120, which may allow large inlet sizes and bypass ratios. Propulsion Engines 110 may be pivoted about the X-axis, for example, by electric engines or hydraulic systems. The pivoting may be provided using a direct drive, or through worm gears, for example. A worm gear may have a high gear ratio, which may allow the use of a small motor to pivot Propulsion Engines 110. One having skill in the art will recognize that many different techniques may be used to pivot Propulsion Engines 110. Propulsion Engines 110 may be offset from one another relative to each of the X-axis and Y-axis, which may reduce interference from one another, for example, exhaust from one entering an intake of the other, while traveling along either the X-axis or Y-axis.

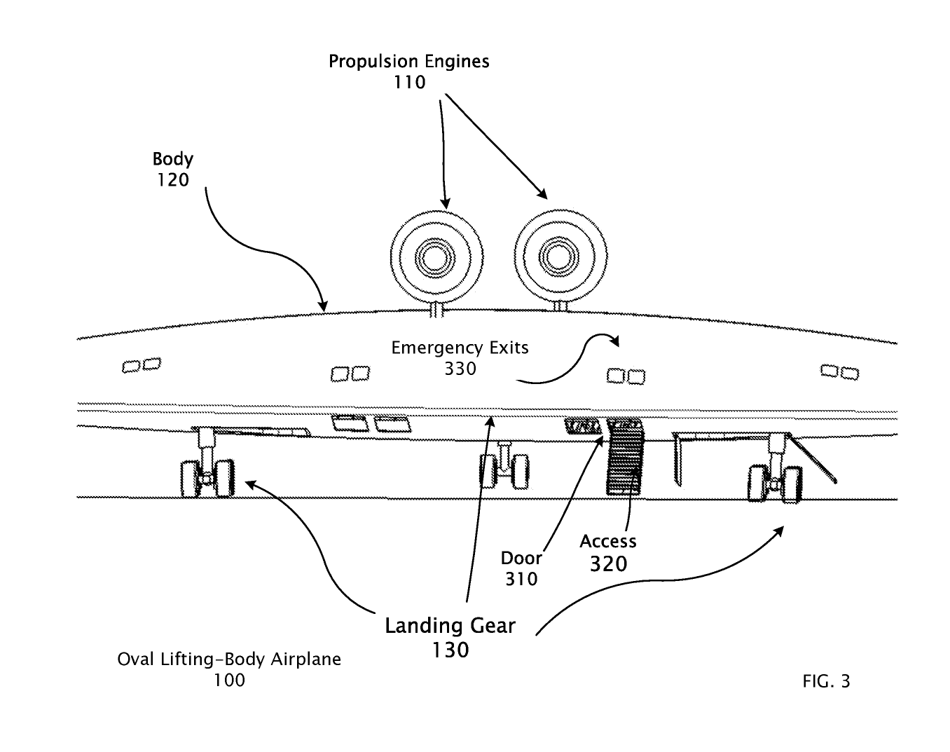

FIG. 3 illustrates a front view of Oval Lifting-Body Airplane 100 with Door 310 open. In this example, Door 310 may be located on lower part of Body 120, with Access 320, which may extend from underneath the aircraft to the ground to facilitate the loading or unloading of passengers, crew, and cargo. Access 320 may be a ramp, stairs, Emergency Exits 330, or other means to provide access to Door 310. In other embodiments, Door 310 may be on Upper Surface 410, and a jet bridge may be used for passenger or cargo access.

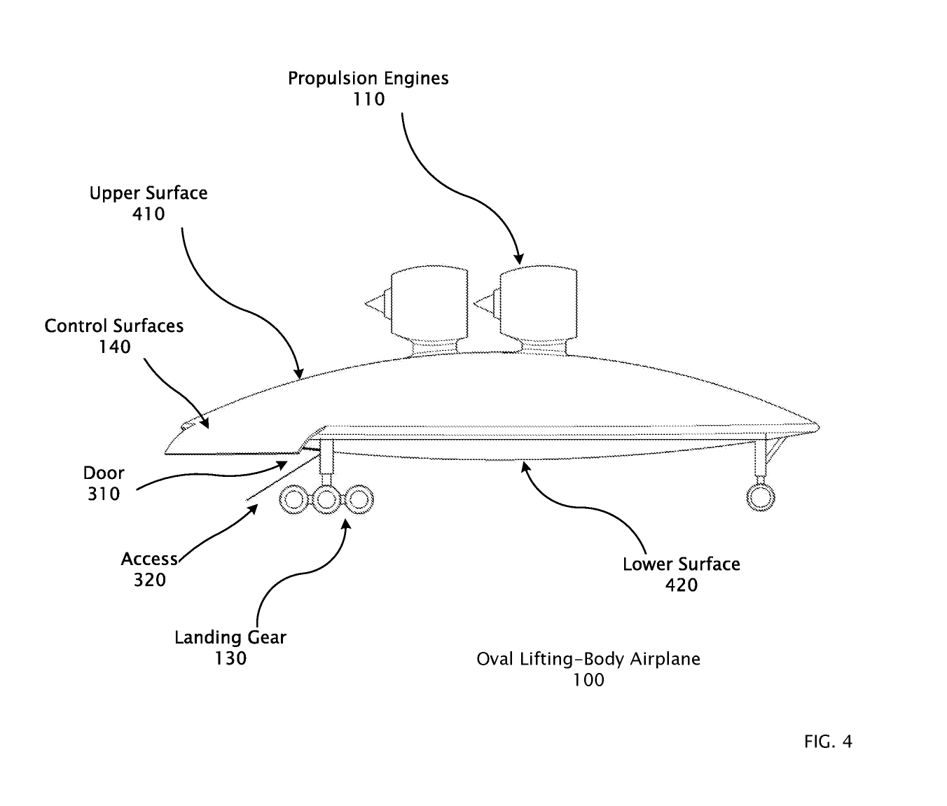

FIG. 4 illustrates a side view of Oval Lifting-Body Airplane 100 with Door 310 open and Access 320 providing access. Body 120 may include Upper Surface 410 and Lower Surface 420. Upper Surface 410 may have more of a curvature than Lower Surface 420, which may generate lift during flight. The curvature of Upper Surface 410 may be constant along the X-axis and along the Y-axis.

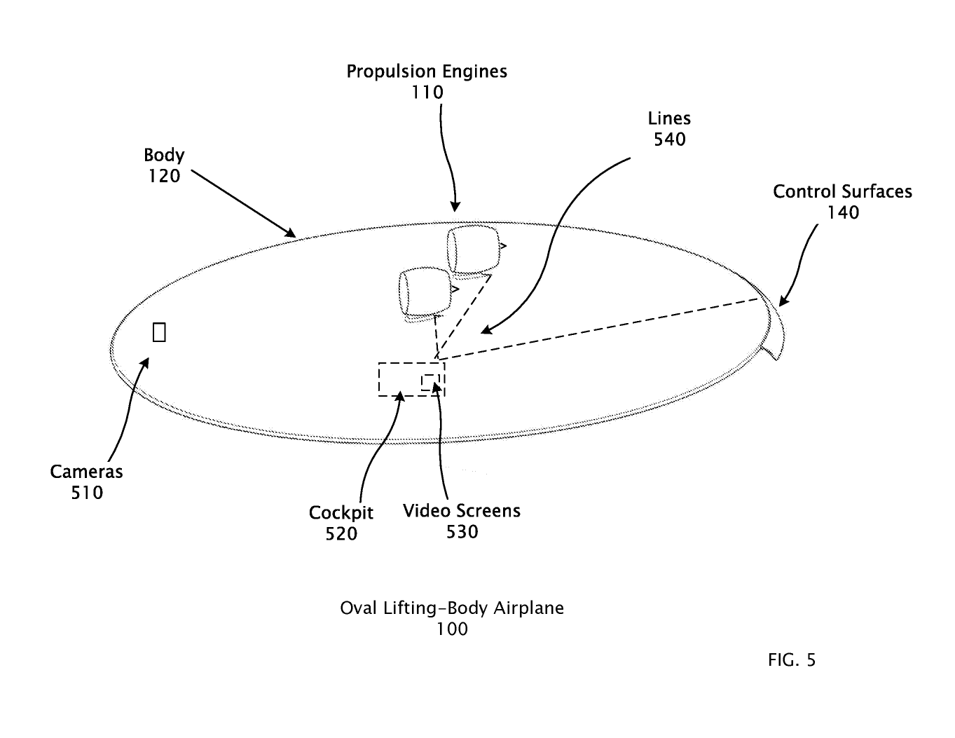

FIG. 5 illustrates an isometric view of Oval Lifting-Body Airplane 100 as it may look while in cruising flight. Oval Lifting-Body Airplane 100 may fly in line with its X-axis or its Y-axis. Using the X-axis direction for ascent and descent may provide a higher lift at a lower speed. In this configuration, shorter runways may be used. This may also lower operating costs by allowing cruising altitudes to be reached more quickly and efficiently. Lines 540, such as hydraulic lines, pneumatic lines, or data lines, may be shorter in length than those found in a conventional airplane built for similar capacity as Oval Lifting-Body Airplane 100. For cruising, Oval Lifting-Body Airplane 100's body may be rotated approximately 90 degrees which may reduce drag while still providing sufficient lift, and may allow cruising at approximately Mach 0.85. Rotating to fly in the X-axis direction may reduce drag, which may reduce fuel consumption by approximately 40% per passenger as compared to a conventional airplane of similar capacity, and may allow a higher cruising speed. Oval Lifting-Body Airplane 100 may roll or turn by using left and right Control Surfaces 140 to control pitch and differential movement to control roll. Lines 540 may be electrical wires, hydraulic lines, mechanical linkages, water, pneumatic lines, data lines, or wastewater lines. Lines 540 may be shorter than a conventional airplane; for example, hydraulic lines, pneumatic lines, or data lines may have a maximum length that is within 55% of the length of the major axis.

Oval Lifting-Body Airplane 100 may be controlled remotely, by an autopilot, or by a pilot in Cockpit 520, which may be located anywhere on Oval Lifting-Body Airplane 100. Oval Lifting-Body Airplane 100 may use fly-by-wire technology. Pilots may see from the airplane by use of one or more Cameras 510 and one or more Video Screens 530, which may be placed in and on multiple locations of Body 120. Cameras 510 and Video Screens 530 may provide panoptic views of interior and exterior of Oval Lifting-Body Airplane 100 and surrounding area. This control-by-wire may allow pilots to remain in a constant location while Oval Lifting-Body Airplane 100 is flying aligned with the X-axis or the Y-axis, with Video Screens 530 adjusting for the direction of flight.

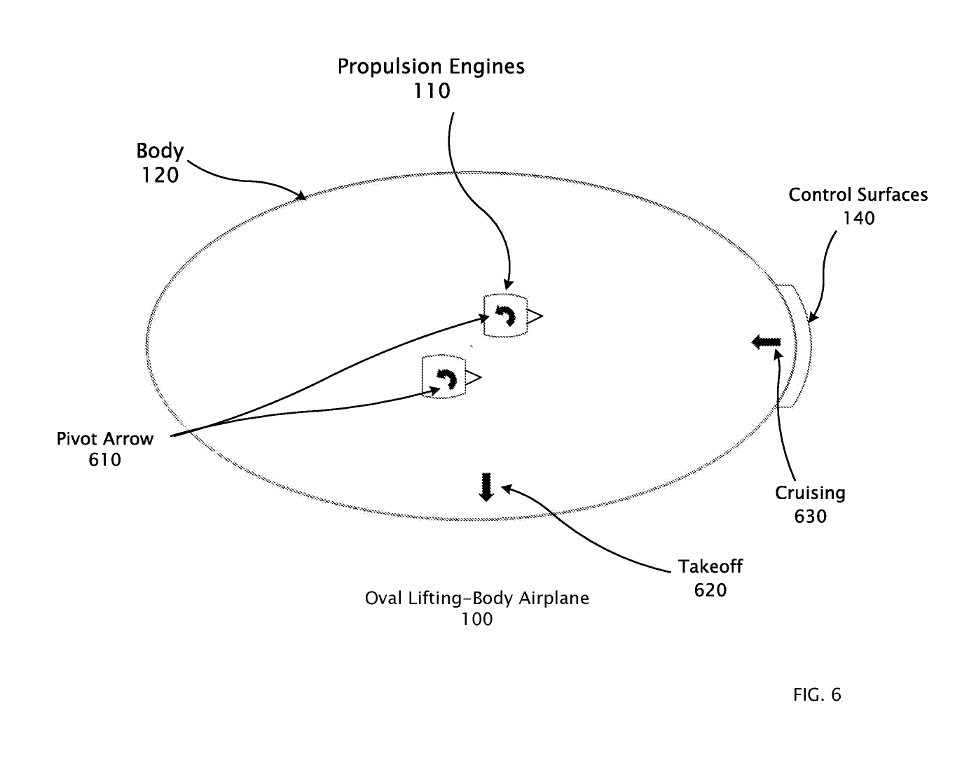

FIG. 6 illustrates a top view of Oval Lifting-Body Airplane 100 while flying in cruising configuration. Propulsion Engines 110 may be attached to Upper Surface 410, which may allow large inlet sizes and bypass ratios. Propulsion Engines 110 may be pivoted about the X-axis, for example, by electric engines or hydraulic systems. Pivot Arrow 610 illustrates a range of motion for pivoting turn of Propulsion Engines 110. The torque may be provided using a direct drive, or through worm gears, for example. Propulsion Engines 110 may pivot approximately 90 degrees to propel the airplane along either the X-axis or Y-axis. Takeoff 620 illustrates fly direction for takeoff with Control Surfaces 140 retracted of Oval Lifting-Body Airplane 100, which may be substantially parallel to a minor axis of an oval shape (X-axis), and Cruising 630 illustrates direction Oval Lifting-Body Airplane 100 may fly in cruising configuration (Y-axis), substantially parallel to a major axis of an oval shape. One having skill in the art will recognize that many different techniques may be used to pivot Propulsion Engines 110. Propulsion Engines 110 may be offset from one another relative to each of the X-axis and Y-axis, which may reduce interference from one another along either the X-axis or Y-axis.

Oval Lifting-Body Airplane 100 may produce less noise at ground compared to a conventional airplane level as a result of placing Propulsion Engines 110 on Upper Surface 410. Placing Propulsion Engines 110 on Upper Surface 410 may also reduce turbulence.

Compact Body 120 of Oval Lifting-Body Airplane 100 may reduce accident damage or withstand accident damage. For example, Oval Lifting-Body Airplane 100 has no wings to collide with other airplanes or structures, and Propulsion Engines 110 may be intact after an accident since they may be mounted on Upper Surface 410. With fewer parts projecting from Body 120, for example, wings, tails, canards, or stabilizers, there may be less likelihood of an accident tearing parts off of Body 120. Control surfaces and other protrusions may not project more than 2.5 meters from Body 120. Body 120 may also reduce weight, production complexity and costs, and operating costs, while improving reliability.

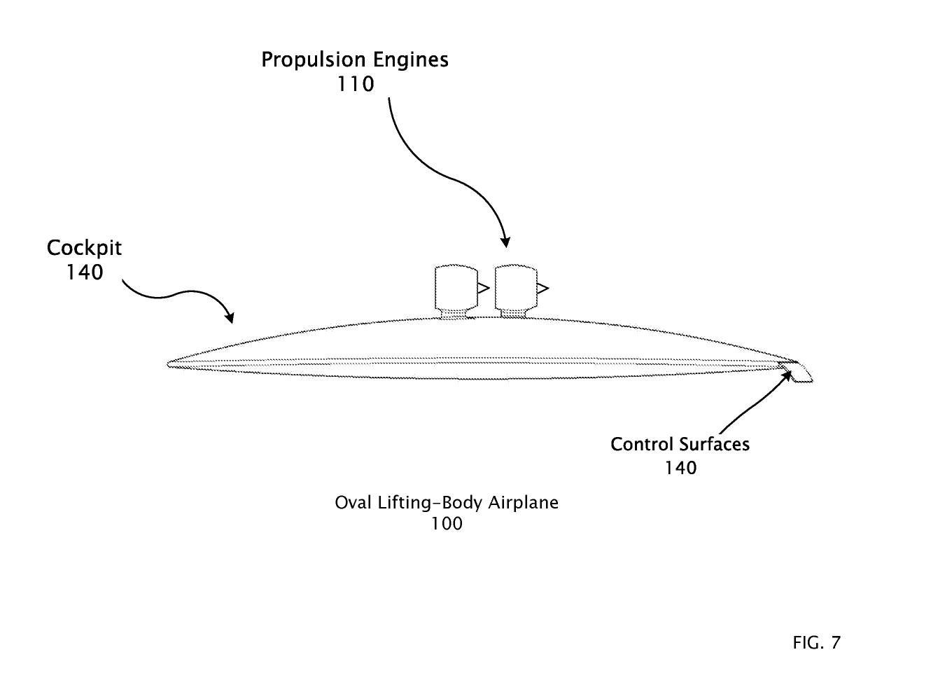

FIG. 7 illustrates a side view of Oval Lifting-Body Airplane 100 while flying as it would look from a side while flying along its X-axis.

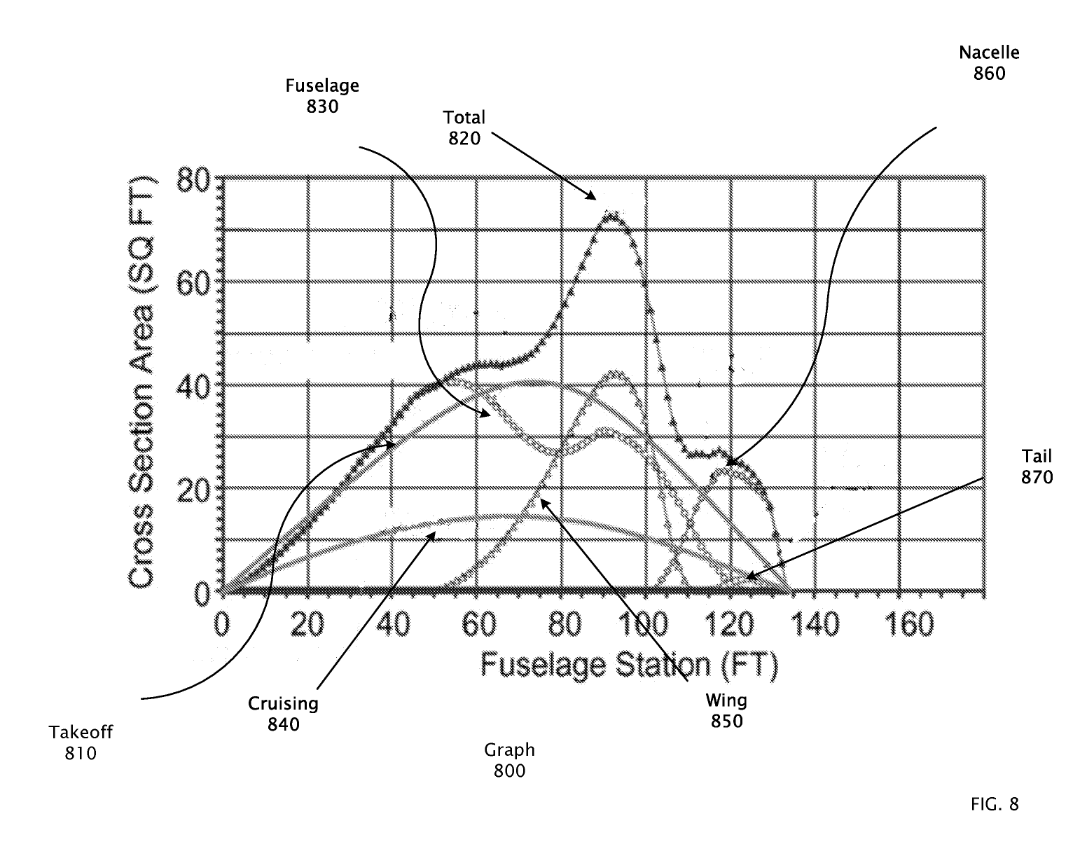

FIG. 8 is a Graph 800 that represents a flight simulation outlining wave drag created by a conventional airplane as compared to Oval Lifting-Body Airplane 100. Graph 800 shows cross-sectional area versus Fuselage 830 station for a conventional airplane and Oval Lifting-Body Airplane 100. Oval Lifting-Body Airplane 100 may have a surface with constant curvature along each of the X-axis and the Y-axis of the oval shape. As a supersonic flow develops around the airplane, the shock waves may form as airflow reaches supersonic speed. These shock waves may generate drag and may require significant thrust to overcome. Oval Lifting-Body Airplane 100 at Takeoff 810 illustrates a smooth curve representing that the cross-sectional area is changing smoothly, reflected by airflow from one end of the airplane through the cross-sectional area of the airplane and to the tail. Oval Lifting-Body Airplane 100 at Cruising 840 has a smooth curve representing a gradual change in cross-sectional area. The smooth curves may reflect fewer abrupt changes in cross-sectional area of the Oval Lifting-Body Airplane 100. A Wing 850, Nacelle 860, Tail 870, and Total 820 of a conventional airplane does not have a constant curvature which may reflect abrupt changes in airflow.

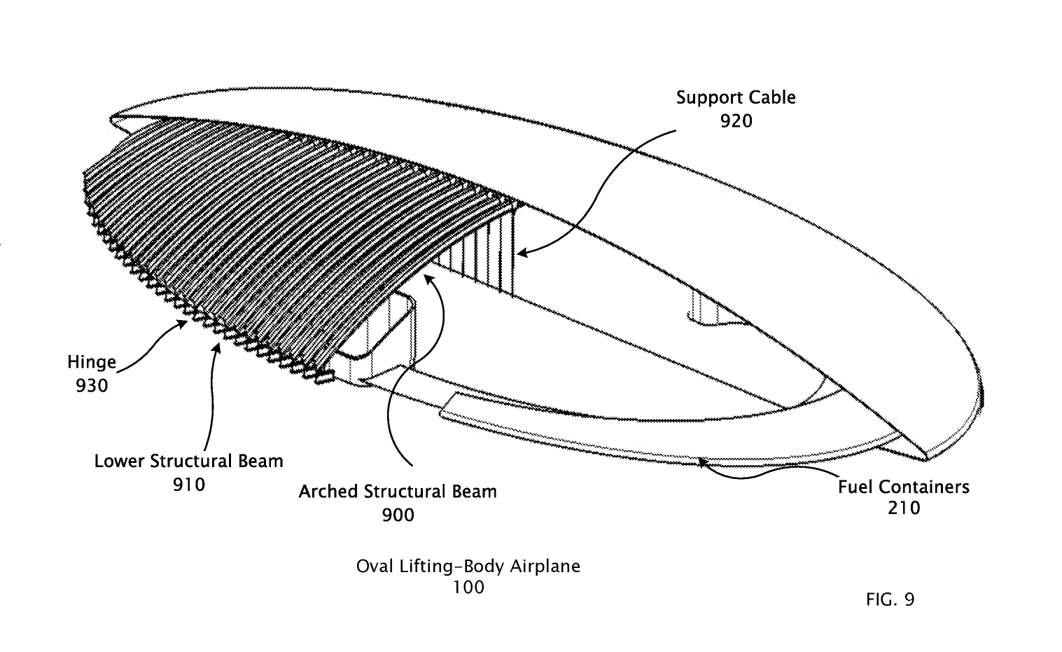

FIG. 9 illustrates an isometric cutout view of Oval Lifting-Body Airplane 100 showing Arched Structural Beams 900. Arched Structural Beams 900 may be curved I-beams which align with the X-axis, and may support Upper Surface 410. In one embodiment, Arched Structural Beams 900 may have a constant curvature. For a given wingspan, each Arched Structural Beams 900 may have a uniform profile and constant curvature. Having Arched Structural Beams 900 with a constant curvature may help reduce manufacturing costs. Lower Structural Beams 910 may be I-beams which align with the X-axis, and may support the Lower Surface 420. Lower Structural Beams 910 may be coupled to Arched Structural Beams 900 using a Hinge 930, which may be made of titanium or another lightweight, corrosion-resistant material, and have moving components that allow for a secure, flexible joint. Support Cable 920 may reduce bending stress, which may reduce the stress on the Arched Structural Beam 900 and Lower Structural Beam 910 near the center of Oval Lifting-Body Airplane 100, by approximately one-quarter. For example, for a wingspan of 55 meters and with an internal pressure of 50 KPa, the maximum bending moment on may be 529 KNm without Support Cable 920, but 132 KNm with Support Cable 920.

In one embodiment, Arched Structural Beams 900 may have a constant curvature as arcs made from a circle do. For a given wingspan, each of Arched Structural Beams 900 may have a uniform profile and constant curvature. Lower Structural Beams 910 may also have a uniform profile and constant curvature. Having Arched Structural Beams 900 and Lower Structural Beams 910 with a constant curvature may help reduce manufacturing costs. For example, for a wingspan of 55 meters, Arched Structural Beam 900 may each be an arc of a circle having a radius of 33.4 meters, while Lower Structural Beam 910 may each be an arc of a circle with a radius of 92.8 meters. For another example, for a wingspan of 40 meters, Arched Structural Beam 900 may each be an arc of a circle having a radius of 25.0 meters, while Lower Structural Beam 910 may each be an arc of a circle with a radius of 59.0 meters.

One having skill in the art will recognize that curvatures for each of Arched Structural Beams 900 and Lower Structural Beams 910 may be varied to provide differences in flying attributes, manufacturing processes and costs, or for other reasons.

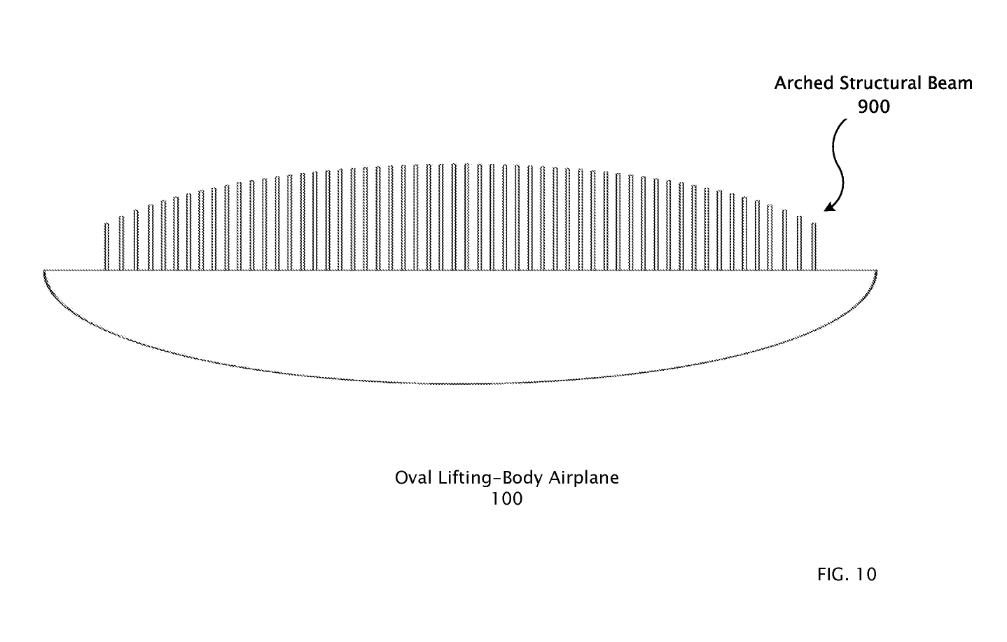

FIG. 10 illustrates a side cutaway view of Oval Lifting-Body Airplane 100 showing Arched Structural Beams 900 that may be aligned with the X-axis of Oval Lifting-Body Airplane 100. Arched Structural Beams 900 may have a constant curvature.

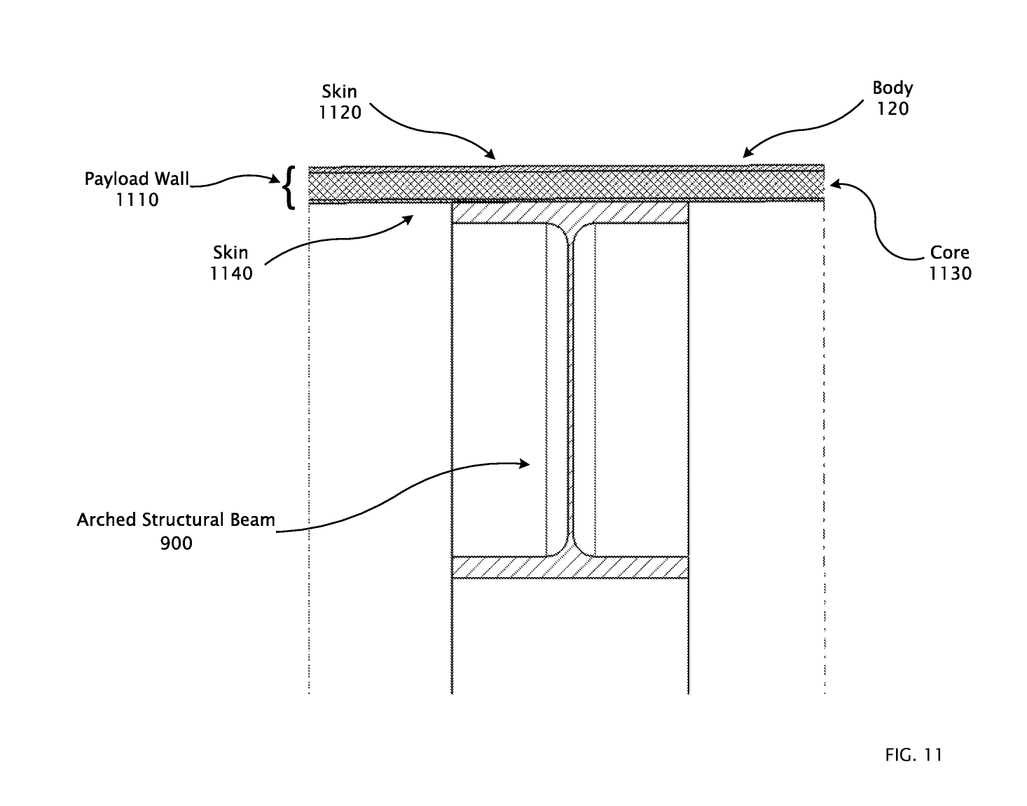

FIG. 11 illustrates a section of Arched Structural Support Beam 910 and a portion of Body 120 of Oval Lifting-Body Airplane 100. Body 120 may have a Payload Wall 1110 made of a sandwich-structured composite material. Skin 1120 and Skin 1140 may be a thin, stiff material, such as aluminum or carbon fiber, while Core 1130 may be a thicker lightweight material. Core 1130 may have a honeycomb or hard foam structure, which may provide added strength or insulating properties.

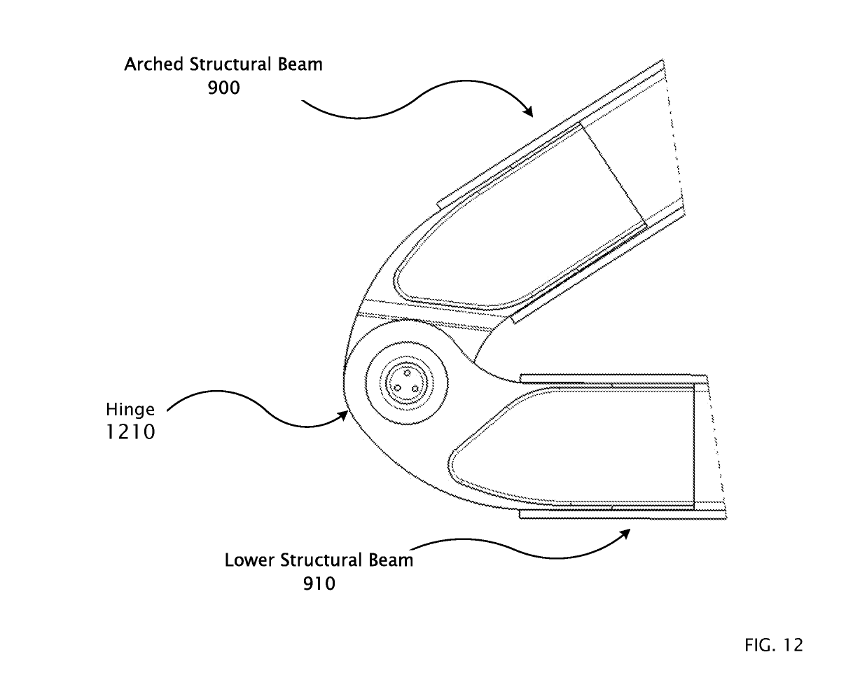

FIG. 12 illustrates a side view of a joint between Arched Structural Support Beam 900 and Lower Structural Beam 910. During changes of pressure which may occur during various phases of flight, as well as flex during landing, for example, forces may cause moments between Arched Structural Support Beam 900 and Lower Structural Beam 910. Hinge 1210 may allow for a flexible joint between Arched Structural Support Beam 900 and Lower Structural Beam 910, which may reduce moments and hence reduce fatigue between them.

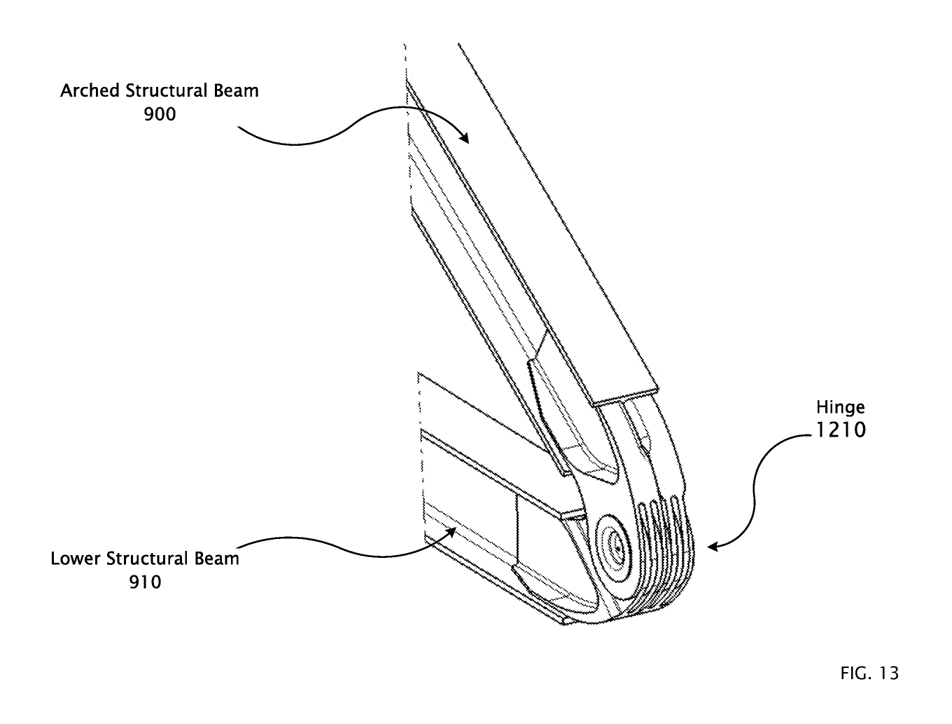

FIG. 13 illustrates an isometric view of a joint between Arched Structural Support Beam 900 and Lower Structural Beam 910.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples, and data provide a complete description of the manufacture and use of the invention. Since many embodiments of the invention can be made without departing from the spirit and scope of the invention, the invention resides in the claims hereinafter appended.

1. An airplane, comprising:
a body, comprising:
an oval shape in a plane of flight, the oval shape having a major axis and a minor axis; and
an upper surface, the upper surface having a constant curvature along a minor axis of the oval shape and a constant curvature along a major axis of the oval shape;
at least one means of propulsion, the means of propulsion coupled to the body via a pivoting means; and
at least one control surface.

2. The airplane of claim 1, further comprising hydraulic lines, pneumatic lines, or data lines wherein each of the hydraulic lines, pneumatic lines, or data lines have a maximum length within 55% of a length of the major axis.

3. The airplane of claim 1 wherein the control surface is operated using fly-by-wire technology.

4. The airplane of claim 1 wherein the control surface is operated using control-by-wire technology.

5. The airplane of claim 1 wherein the control surface is selected from the group consisting of flaps, elevators, ailerons, rudders, slats, and air brakes.

6. The airplane of claim 1 wherein the control surface comprises movable surfaces operable to adjust an attitude of the airplane.

7. The airplane of claim 6, wherein a maximum protrusion from the body of the control surface is 2.5 meters.

8. The airplane of claim 1 further comprising a system which rotates the body in the plane of flight between flying parallel to the minor axis during ascent and descent phases of a flight and flying parallel to the major axis during a cruise phase of the flight.

9. The airplane of claim 8 wherein an aspect ratio of the body during the cruise phase is less than 50% of an aspect ratio during an ascent phase.

10. The airplane of claim 1 comprising a seating area, wherein seats are arranged in rows of two, operable to provide aisle access for each seat.

11. The airplane of claim 1 wherein the upper surface comprises a sandwich-structured composite material coupled to a first curved I-beam support structure.

12. The airplane of claim 11 wherein the first curved I-beam support structure has a constant curvature with a radius of between 20 and 40 meters.

13. The airplane of claim 1 further comprising a lower surface, the lower surface comprising a sandwich-structured composite material coupled to a second curved I-beam support structure.

14. The airplane of claim 13 wherein the second curved I-beam support structure has a constant curvature with a radius between 55 and 100 meters.

15. The airplane of claim 14 wherein the first curved I-beam support structure and second curved I-beam support structure are coupled using a flexible joint.
